(19) United States
(12) Patent Application Publication
(10) Pub. No.: US 2014/0111625 A1
(43) Pub. Date: Apr. 24, 2014

(54) APPARATUS AND METHOD FOR MEASURING GOLF CLUB SHAFT FLEX AND GOLF SIMULATION SYSTEM INCORPORATING THE SAME

(71) Applicant: Interactive Sports Technologies Inc., Vanghan (CA)

(72) Inventors: Wayne Dawe, Richmond Hill (CA); Zuqiang Zhao, Richmond Hill (CA)

(73) Assignee: Interactive Sports Technologies Inc., Vaughan (CA)

(21) Appl. No.: 14/141,786

(22) Filed: Dec. 27, 2013

Related U.S. Application Data
(63) Continuation of application No. 13/041,967, filed on Mar. 7, 2011, now abandoned.
(60) Provisional application No. 61/311,127, filed on Mar. 5, 2010.

(51) Int. Cl. G06T 7/00; H04N 13/02; H04N 7/18

(52) U.S. Cl. CPC G06T 7/004; H04N 7/18; H04N 13/02
USPC 348/47; 382/103; 348/135

(57) ABSTRACT

A method for measuring shaft flex comprises capturing at least one image of a shaft during movement of the shaft through a swing plane and examining the at least one image to determine the flex of the shaft.

### CROSS-REFERENCE TO RELATED APPLICATIONS

This application claims the benefit of U.S. Provisional Application No. 61/311,127 to Dawe et al. filed on Mar. 5, 2010 entitled “Apparatus and Method for Measuring Golf Club Shaft Flex and Golf Simulation System Incorporating The Same”, the content of which is incorporated herein by reference in its entirety.

### FIELD OF THE INVENTION

The present invention relates generally to sports measurement systems and in particular, to an apparatus and method for measuring golf club shaft flex and to a golf simulation system incorporating the same.

### BACKGROUND OF THE INVENTION

The goal of all sports equipment is to provide athletes with a piece of equipment that will enable the athletes to perform at their best. Many parameters factor into the design of sports equipment, such as weight, length, torque, flex, etc. For example, hockey sticks are sold in a variety of flexes and weights tailored towards specific sizes of hockey players. A young child learning to play hockey is typically best suited to use a short, light weight, soft flex hockey stick, while a professional hockey player is typically best suited to use a long, heavy, stiff flex hockey stick. Other types of sports equipment such as baseball bats, golf clubs, tennis racquets etc. are similarly sold in a variety of forms tailored to fit certain “types” of athletes.

Certain types of sports equipment rely on the flex of a shaft to help an athlete perform their best. For example, golf club manufactures produce golf club shafts of different lengths and flexes for selection by individual golfers. Most golfers rely on the expertise of golf club fitters to recommend the best type of golf club shaft for their particular size and skill. In the past, golf club fitters would measure the swing speed of a golfer and from this measurement select a golf club shaft type for the golfer. Unfortunately, selecting a golf club shaft type based on a swing speed measurement is highly speculative resulting in inaccurate golf club shaft fitting.

To address this problem, techniques to measure golf club shaft flex have been considered. For example, U.S. Pat. No. 7,292,070 to Ashida et al. describes a golf club shaft selecting system including a head speed detecting unit for detecting club head speed at impact in a swing of a golfer, a swing tempo detecting unit for detecting the swing tempo of the golfer, a chart indicative of a shaft mass and a shaft flex point corresponding to the swing characteristics of the golfer, a selecting unit for selecting a golf club shaft suitable for the golfer referring to the chart and based on the club head speed and the swing tempo detected by the head speed detecting unit and the swing tempo detecting unit respectively, and a displaying apparatus for displaying the golf club shaft selected by the selecting unit.

U.S. Pat. No. 7,041,014 to Wright et al. describes a method for matching a test golfer with a particular golf club selected from a group of golf clubs having a plurality of styles. The method utilizes a data set derived in an initial procedure in which the club style preferences for each of a large number of pre-test golfers is recorded and correlated with a set of performance parameters for the golf swings of such pre-test golfers. The data set enables the pre-test golfers to be classified into subgroups, in which golfers within the same subgroup generally prefer the same club style and golfers in different subgroups generally prefer different club styles. During the method, while a golfer takes a golf swing with a golf club, performance parameters for the swing are measured. Based on the measured performance parameters and the previously established data set, the test golfer is classified according to swing type, and the optimum golf club is then selected from the plurality of styles of golf clubs.

U.S. Pat. No. 5,616,832 to Nauck describes a system and method for the evaluation of dynamics of a golf club comprising a microphone inserted inside the golf club shaft which detects vibrations as sound waves and transmits signals indicative of the vibration's frequencies and amplitudes to a data acquisition system for processing, display and analysis. The apparatus may also be used for measuring natural frequency of flex through use of a rattler or a micro-switch actuator.

Although the above references describe techniques to measure a golf swing and select a golf club shaft, improvements are desired. It is therefore an object of the present invention at least to provide an apparatus and method for measuring golf club shaft flex and a golf simulation system incorporating the same.

### SUMMARY OF THE INVENTION

Accordingly in one aspect there is provided a method for measuring shaft flex comprising capturing at least one image of a shaft during movement of the shaft through a swing plane; and examining the at least one image to determine the flex of the shaft.

In one embodiment, the capturing comprises capturing a series of images during movement of the shaft through the swing plane and the examining comprises examining multiple images to determine the flex of the shaft at multiple positions along the swing plane. The examining may comprise determining a flex profile for the shaft over the movement of the shaft through the swing plane. The examining may also comprise measuring a deviation of at least one discrete point along the shaft from a fixed reference to determine shaft flex. The fixed reference may be a straight line extending between a pair of reference points adjacent opposite ends of the shaft. The at least one discrete point and the pair of reference points may be defined by reflective markings on the shaft. The shaft may be the shaft of a golf club.

According to another aspect there is provided an apparatus for measuring shaft flex comprising at least one imaging device capturing images of a shaft during movement of the shaft through a swing plane; and a processing unit receiving images from the at least one imaging device, and processing received images to determine the flex of the shaft.

In one embodiment, the optical axis of the at least one imaging device is generally perpendicular to the swing plane. The apparatus may further comprise an illumination source. The at least one imaging device captures a series of images of the shaft during movement of the shaft through the swing plane and the processing structure is configured to process multiple images to determine the flex of the shaft at multiple positions along the swing plane.

According to yet another aspect there is provided a golf simulation system comprising an apparatus for measuring golf club shaft flex as described above: a golf ball tracking apparatus comprising at least two imaging devices capturing images of a golf ball tracking region disposed in front of a display surface from different vantages to detect a launched golf ball traveling through the golf ball tracking region towards the display surface; a golf ball spin sensing unit capturing images of a region at least partially overlapping with the golf ball tracking region, each captured image comprising a golf ball trail representing a travel path of the golf ball when a golf ball is present in the region during image capture; and at least one processing unit receiving data from the imaging devices and the golf ball spin sensing unit and determining the three-dimensional positions, velocity, acceleration and spin of a detected launched golf ball traveling through the golf ball tracking region, the three-dimensional positions, velocity, acceleration and spin being used by the at least one processing unit to calculate a trajectory of the launched golf ball into a three-dimensional golf scene.

### BRIEF DESCRIPTION OF THE DRAWINGS

Embodiments will now be described more fully with reference to the accompanying drawings in which:

FIG. 1 is a schematic, partial side elevational view of an apparatus for measuring golf club shaft flex;

FIG. 2 is a schematic perspective view of a golf club for use with the apparatus of FIG. 1;

FIGS. 3a to 3h are front elevational views of a user swinging the golf club of FIG. 2;

FIGS. 4a and 4b show images of the golf club shaft during a golf swing captured by an imaging device forming part of the apparatus of FIG. 1;

FIG. 5 is a side elevational view of the golf club of FIG. 2 at the top of a golf swing;

FIG. 6 is a graph showing the flex ratio at three points along the golf club of FIG. 2 during a golf swing:

FIG. 7 is a graph showing the shaft angle of the golf club during a golf swing;

FIG. 8 is a graph showing the maximum flex ratio and the shaft angle of the golf club of FIG. 2 during a golf swing;

FIG. 9 is a graph showing the angular velocity and acceleration of the golf club of FIG. 2 during a golf swing;

FIG. 10 is a perspective view of a golf simulation system incorporating the apparatus of FIG. 1;

FIG. 11 is a side elevational view of the golf simulation system of FIG. 10;

FIG. 12 is a top plan view of the golf simulation system of FIG. 10;

FIG. 13 is a front elevational view of a golf ball tracking apparatus forming part of the golf simulation system of FIG. 10;

FIG. 14 is an enlarged front elevational view, partly in section, of a portion of the golf ball tracking apparatus of FIG. 13;

FIG. 15 is a side schematic view of a golf ball launch area sensing unit forming part of the golf simulation system of FIG. 10;

FIG. 16 is a schematic perspective view of a golf ball spin sensing unit forming part of the golf simulation system of FIG. 10;

FIG. 17 is a schematic block diagram of an area-scan digital camera forming part of the golf ball spin sensing unit of FIG. 16;

FIG. 18 is a schematic block diagram of an illumination board driver and illumination boards forming part of the golf ball spin sensing unit of FIG. 16;

FIG. 19 shows a backward spinning launched golf ball;

FIGS. 20 to 23 are flowcharts showing steps performed during player interaction with the golf simulation system of FIG. 10;

FIG. 24 is an overhead view of a golf club making impact with a golf ball within the launch area of the golf simulation system of FIG. 10; and

FIG. 25 shows processing of captured images to determine golf ball spin and golf ball spin tilt axis.

### DETAILED DESCRIPTION OF THE PREFERRED EMBODIMENT

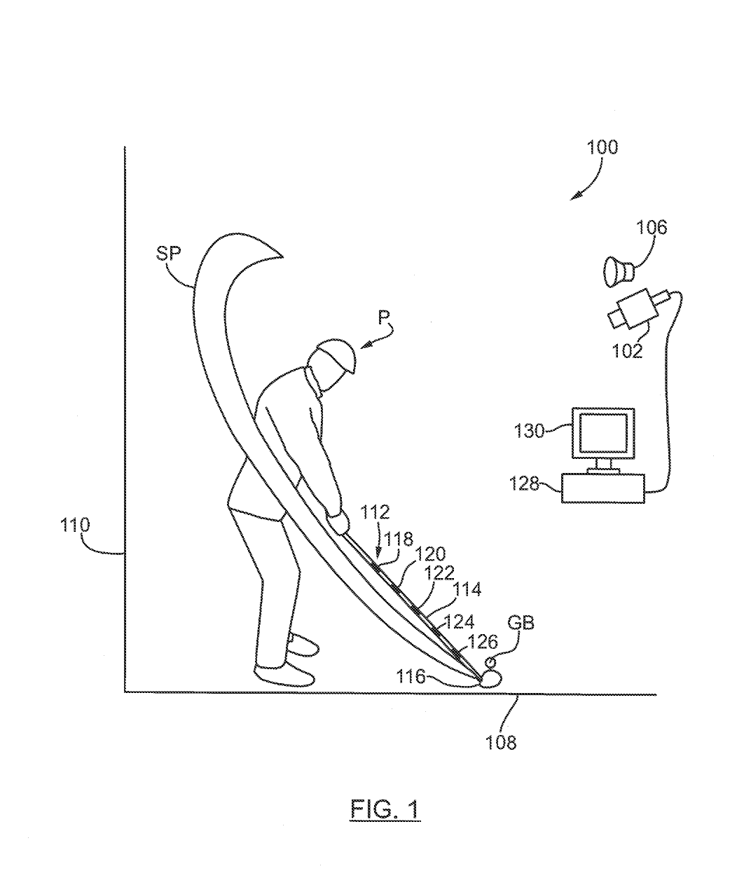

Turning now to FIG. 1, an apparatus for measuring golf club shaft flex is shown and is generally identified by reference numeral 100. As can be seen, the apparatus 100 comprises an imaging device 102 positioned to capture images of a golf ball launch or hitting area in which a player P swinging a golf club 112 stands. The optical axis of the imaging device 102 is positioned to be generally perpendicular an anticipated swing plane SP of the player P. A light source 106 is positioned adjacent the imaging device 102 to illuminate generally evenly the launch area. The hitting area has a non-reflective floor 108 and a non-reflective background 110. A computing device 128 such as for example, a personal computer or other suitable processing unit or structure is coupled to the imaging device 102. The computing device 128 processes image frames received from the imaging device 102 to determine the shaft flex of the golf club 112 throughout the swing of the golf club and to display the results as will be described.

In this embodiment, the non-reflective background 110 is in the form of a curtain or wall covering formed of a non-reflective material that is coated with an acrylic. Similarly, the non-reflective floor 108 comprises a carpet or floor covering formed of a similar non-reflective material. In this embodiment, imaging device 102 is a digital camera that has at least a 640 by 480 pixel array and an electronically controlled shutter and that captures image frames at a frame rate of at least sixty (60) frames per second. As mentioned above, light source 106 evenly illuminates the launch area providing suitable light for the player P to swing the golf club 112 and hit a golf ball GB and for the imaging device 102 to capture image frames that include image data that can be processed to determine shaft flex. In this embodiment, light source 106 comprises a plurality of halogen lights mounted on a track lighting fixture.

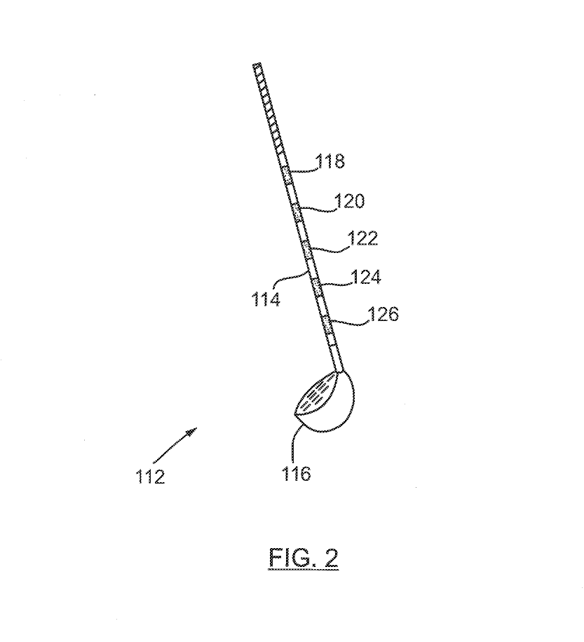

Turning now to FIG. 2, the golf club 112 is better illustrated. As can be seen, the golf club 112 comprises a flexible shaft 114 having a club head 116 at one end of the shaft 114. To facilitate imaging of the golf club 112 and in particular the shaft 114 during a golf swing, reflective markers are provided on the shaft at spaced locations. In this embodiment, five (5) reflective markers 118 to 126 are provided on the shaft 114. The reflective markers in this embodiment are pieces of retroreflective tape surrounding the shaft 114 at discrete points or locations along the length of the shaft. The dimensions of the retroreflective tape pieces can vary but are selected so that the retroreflective tape pieces can be easily identified in image frames captured by the imaging device 102. In this example, each piece of retroreflective tape has a length equal to about one (1) inch.

The positions of the reflective markers 118 to 126 along the shaft 114 are selected to facilitate detection and measurement of the flex of the golf club shaft during a golf swing. In this embodiment, the reflective marker 118 is placed near the top of the shaft 114 adjacent the golf club grip and the reflective marker 126 is placed near the bottom of the shaft 114 adjacent the hozel and club head 116. The reflective marker 122 is placed adjacent the mid-point of the shaft 114. The reflective marker 120 is positioned intermediate the reflective markers 118 and 122 and the reflective marker 124 is positioned intermediate the reflective markers 122 and 126. The reflective markers 118 and 126 are used to determine reference points on the shaft 114 during shaft flex measurement as will be described.

During operation, when it is desired to measure the flex of a golf club shaft 114 during a golf swing, the player P with the golf club 112 in hand stands in the launch area. The light source 106 is operated to provide generally even illumination to the launch area so that the player P has no or little difficulty completing a golf swing and hitting the golf ball GB. When the player P is ready to make a golf swing, the imaging device 102 is conditioned to capture image frames. As a result, when the player P makes a golf swing, substantially the entire golf swing is captured in image frames.

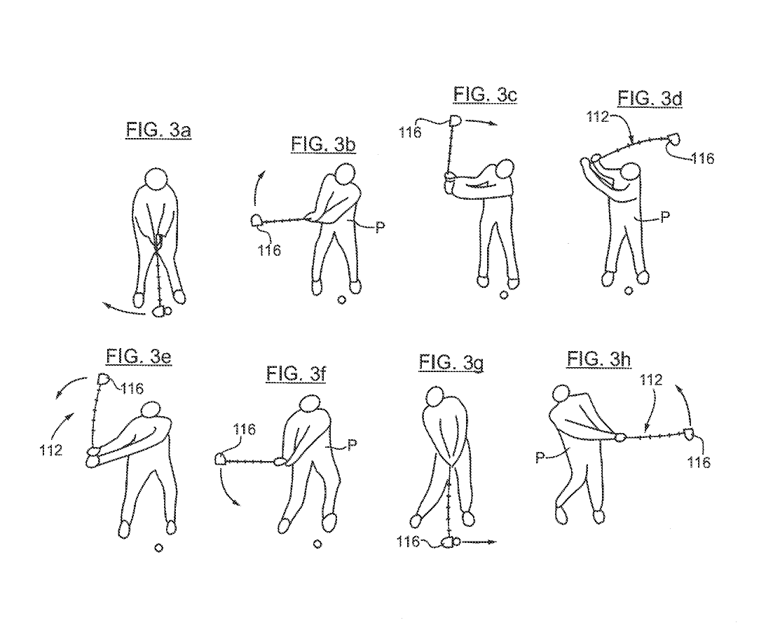

FIGS. 3a to 3h show the golf swing of player P. As can be seen, the golf swing comprises an up-swing component illustrated in FIGS. 3a to 3d and a down-swing component illustrated in FIGS. 3e to 3h. As will be appreciated, the shaft 114 flexes by different amounts over the golf swing depending on the component of the golf swing and the speed of the club head 116 at a particular point of time during the golf swing. For example, as shown in FIG. 3d, the shaft 114 flexes towards player P as the momentum of the club head 116 is still in the up-swing direction while the player's hands begin to move in the down-swing direction.

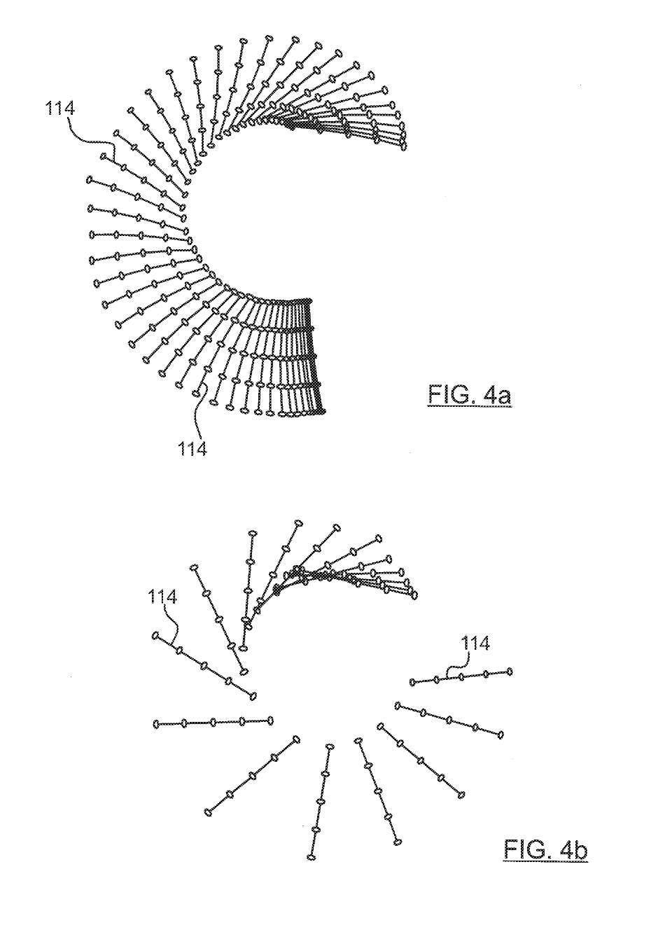

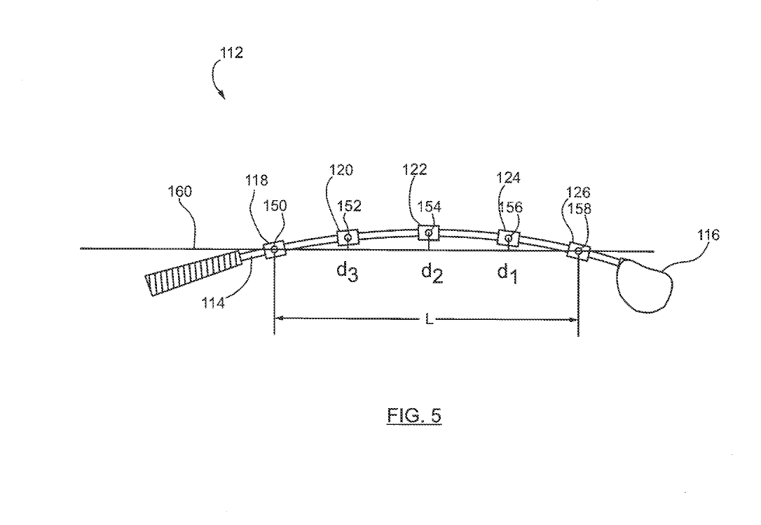

The reflective markers 118 to 126 reflect light towards the imaging device 102 throughout the golf swing while the non-reflective background 110 and non-reflective floor 108 inhibit light from reflecting off of these surfaces towards the imaging device. As a result, the reflective markers 118 to 126 appear as bright spots on an otherwise relatively dark background in captured image frames allowing the reflective markers 118 to 126 to be easily discerned. FIG. 4a shows a sequence of image frames captured by the imaging device 102 during the up-swing component of the player's golf swing while FIG. 4b shows a sequence of image frames captured by the imaging device 102 during the down-swing component of the player's golf swing. As can be seen, the points along the shaft 114 corresponding to the reflective marker locations are easily identified in the captured image frames. The distance the shaft 114 of the golf club 112 travels between each captured image frame is indicative of the acceleration of the club head 116. As can be seen, during the up-swing component of the player's golf swing as shown in FIG. 4a, the distance the shaft 114 of the golf club 112 travels between successive image frames is relatively constant signifying a smooth up-swing. During the down-swing component of the player's golf swing, the distance the shaft 114 of the golf club 112 travels between each pair of successive image frame increases signifying acceleration of the club head 116 during the down-swing until contact is made with the golf ball GB.

FIG. 5 shows the golf club 112 at the position along the player's golf swing shown in FIG. 3d. As can be seen, at this position the shaft 114 of the golf club 112 flexes. As a result, the reflective markers 118 to 126 are no longer positioned along a straight line but rather are positioned along an arcuate line. The positions of the reflective markers 118 to 126 in captured image frames are used to determine and measure the golf club shaft flex. As will be appreciated, the amount of flex in the shaft 114 during a golf swing depends on a variety of factors, such as shaft stiffness, shaft weight, club head weight, torque, kick point, club head speed, etc.

During processing, the computing device 128 processes the captured image frames to measure the flex of the golf shaft 114 at various positions throughout the golf swing. In particular, for each captured image frame, the computing device 128 determines the center point 150 to 158 for each bright spot in the image frame that corresponds to a reflective marker 118 to 126. Center points 150 and 158 are used as the reference points. Once the center points 150 and 158 are determined, the computing device 128 computes a straight line 160 extending between the reference points 150 and 158. Following computation of the straight line 160, the distance between each center point 152, 154 and 156 and the straight line 160 along a line perpendicular to the straight line denoted by d1, d2 and d3, respectively, is measured. Distances d1, d2 and d3 are representative of the amount of flex of the shaft 114 at their respective points. The greater the distance d1, d2, d3 from the straight line 160, the greater the amount of golf club shaft flex. If any of the distances d1, d2, and d3 is equal to zero, there is no flexing of the shaft 114 at that particular point.

As will be appreciated, golf club shafts come in a variety of stiffness and lengths. To accurately compare different golf club shafts, distances d1, d2 and d3 should be normalized. This is done by measuring the length L along the straight line 160 between the reference points 150 and 158. Length L defines a constant value which can be used to normalize distances d1, d2 and d3 as a flex ratio percentage f1, f2 and f3 according to:

$${f}_{i} = \frac{{d}_{i}}{L} \times 100 \% , \\ i = 1 , 2 , 3 …$$

The flex ratio percentage indicates the percentage of flexing at each particular center point 152, 154, and 156. Again, a calculated zero value indicates that there is no flexing of shaft 114 at that particular point. Comparing the three calculated flex ratios allows the maximum flex of the shaft 114 to be calculated according to:

fₘₐₓ=max(f₁,f₂,f₃)

The maximum flex of the shaft 114 is used to represent the flex of the shaft 114 for that image frame. By determining the maximum flex over a series of captured image frames, a flex profile for the shaft 114 over a golf swing can be determined and displayed. A determination can then be made as to whether the shaft flex characteristics of the golf club 112 suit the player's golf swing.

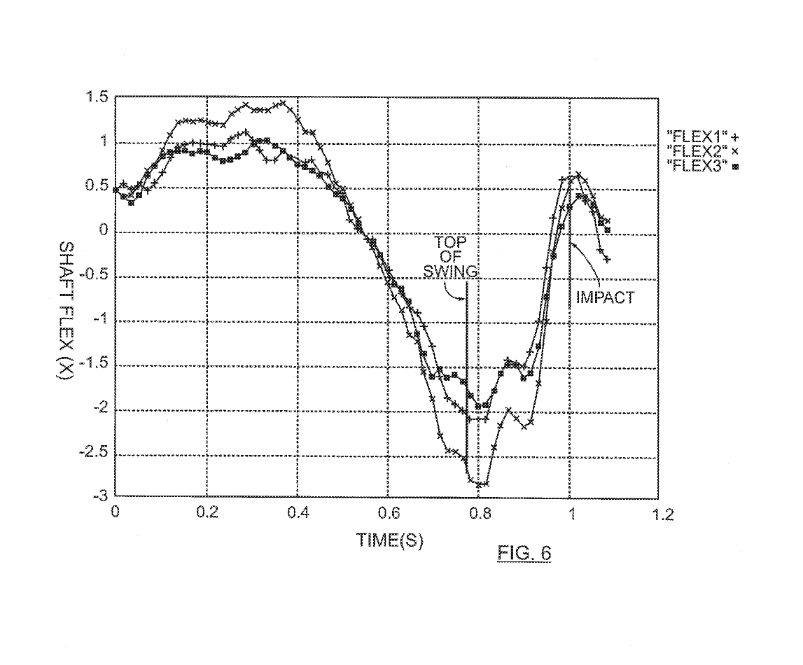

FIG. 6 shows a graphical representation of the flex ratio percentage of the shaft 114 at positions along the shaft corresponding to the reflective markers 120, 122, and 124. The flex ratio percentage is shown along the y-axis, while time is shown along the x-axis. As will be appreciated, a positive flex ratio indicates the flexing of the shaft 114 in a first direction while a negative flex ratio indicates flexing of the shaft in an opposite direction. For each of the center points 152, 154, and 156, the flex ratio crosses the y-axis at two instances indicating that there are two instances during the player's swing in which the flex ratio of the shaft 114 is zero. As can be seen, the maximum flex ratio percentage of shaft 114 almost always corresponds to flex ratio f2. Flex ratio f2 is based on the distance d2 of center point 154 from the straight line 160 and hence, the deviation of the reflective marker 124 that is positioned near the mid-point of the shaft 114 from the straight line 160. This indicates that the kick point of the shaft 114 is located near its mid-point.

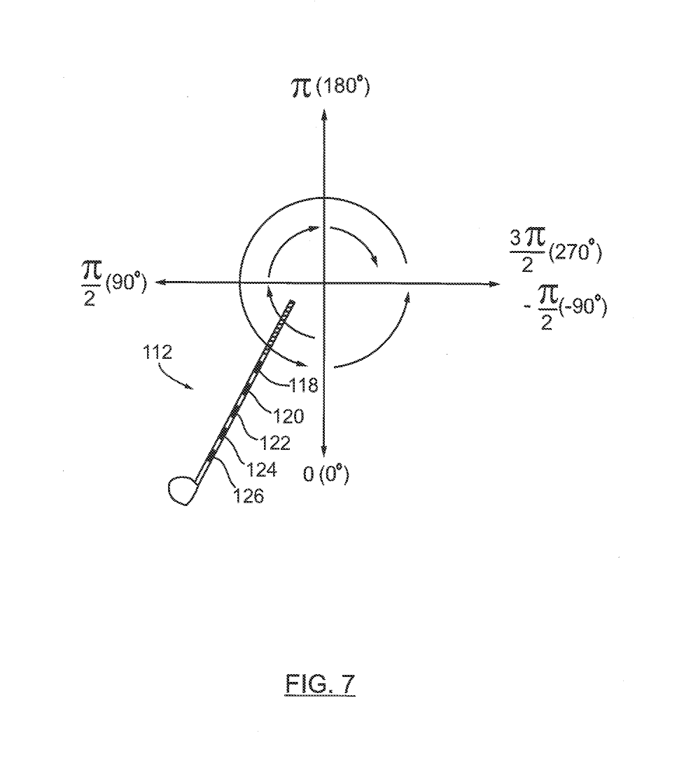

FIG. 7 shows the shaft angle of the golf club 112 during a golf swing. When player P addresses the golf ball GB as shown in FIG. 3a, the shaft 114, when modeled as a vector extending between reflective markers 118 and 126, will be at an angle close to 0 degrees. The reference point of zero (0) degrees is defined as the position of the golf club 112 when the club head 116 contacts the golf ball. The arrows indicate the direction of travel of the club head 116 during both the up-swing and down-swing components of the player's golf swing. As player P takes the club head 116 back, the angle of shaft 114 increases up to a point of approximately 270 degrees, although the maximum angle of the shaft 114 greatly depends upon the golfer making the swing. As player P begins the down-swing, the angle of the shaft 114 begins to decrease. The instant the club head 116 contacts golf ball GB, the angle of the shaft 114 is zero (0) degrees, and through impact, the absolute value of the angle of the golf shaft 114 begins to increase in the negative direction.

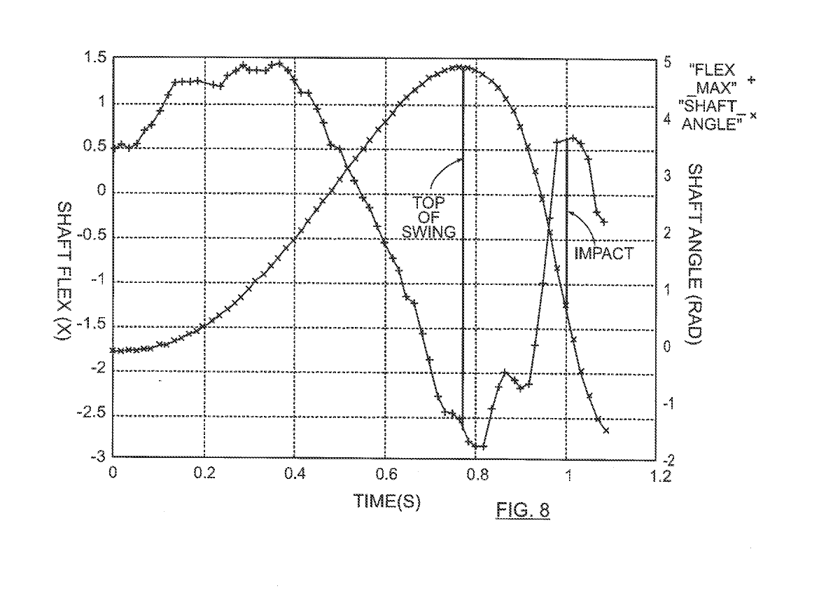

FIG. 8 shows a graphical representation of both the maximum flex ratio (wherein the y-axis has the units of percentage) and the shaft angle (wherein the y-axis has the units of radians). Time is represented along the x-axis. Of particular interest is that the maximum flex ratio occurs approximately when the shaft angle is the greatest. As mentioned previously, the shaft angle is the greatest at the top of the golf swing, where the player P transitions from the up-swing to the down-swing. The first zero-crossing of the maximum flex ratio occurs at approximately 3.5 radians (200 degrees). Turning back to FIG. 7, it can be seen that the shaft 114 begins to flex from the first direction to the second direction during the up-swing, just past the point when the shaft 114 is vertical (180 degrees). The second zero-crossing of the maximum flex ratio occurs during the down-swing at approximately 1.7 radians (97 degrees). Again, turning back to FIG. 7, shaft 114 begins to flex from the second direction to the first direction at a point prior to the club head 116 contacting the golf ball GB. This represents the whipping action of the shaft 114 that occurs prior to the club head 116 contacting the golf ball GB. As one skilled in the art will appreciate, the key to having a properly fit golf club shaft is to have the correct amount of whipping action at impact to optimize golf ball launch and club head speed.

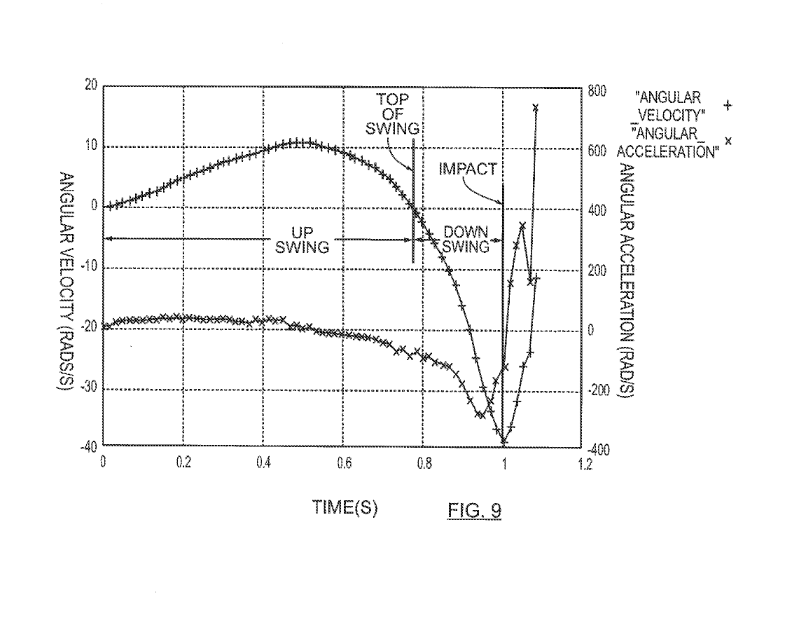

FIG. 9 shows a graphical representation of the angular velocity and acceleration of the golf club shaft 114. Angular velocity is defined as the ratio of the change of angle of the shaft 114 to the time interval between consecutive captured image frames. Angular acceleration is defined as the ratio of change of angular velocity of the shaft 114 to the image frame time interval. The first zero crossing of the angular velocity occurs at the top of the up-swing, at the instant when the club head 116 transitions from the up-swing to the down-swing. The angular velocity transitions from a positive value to a negative value at the top of the up-swing, as the club head 116 begins to travel in the negative direction. The peak acceleration occurs during the down-swing when the shaft 114 is in a generally horizontal position. Referring back to FIG. 7, this corresponds to a shaft angle of approximately 90 degrees. It is interesting to note that the maximum angular velocity occurs after the maximum acceleration occurs, that is, when the club head 116 contacts the golf ball GB. This is because the golf club shaft keeps accelerating during the downswing for a good golf swing. Since the club head 116 is attached to the shaft 114, a maximum angular velocity of shaft at impact generally means a maximum velocity of golf club head at impact. Shaft angle, angular velocity, and angular acceleration of golf club shaft are measured and correlated with measurements of shaft flex. Angular velocity and angular acceleration are good indicators of golf swing tempo and can be used together with shaft flex measurements to provide an enhanced dynamic measurement of golf club shaft flex.

As will be appreciated, the apparatus 100 allows the shaft 114 of the golf club 112 to be determined at various points along the player's golf swing allowing the shaft flex characteristics to be determined and displayed so that a determination can be made as to whether the shaft flex characteristics suit the golfer's swing. This is done without requiring the golf club to be modified to a point where its characteristics change. In this embodiment, the only golf club modification that is made is the placement of retroreflective markers in the form of tape pieces on the shaft 114 at spaced locations. As the rectangular tape pieces are light weight, they have virtually no impact on the golf club 112.

Apparatus 100 as described above with reference to FIGS. 1 to 9 can be used as a stand alone system for club-fitting purposes or can be used in conjunction with a golf simulation system such as those described in U.S. Pat. No. 7,544,137, issued on Jun. 9, 2009 to Richardson; U.S. patent application Ser. No. 11/195,017, filed on Aug. 2, 2005, to Richardson et al.; U.S. patent application Ser. No. 11/394,004, filed on Mar. 30, 2006 to Dawe et al.; and PCT Application No. PCT/CA2009/001424 filed on Oct. 7, 2009 to Dawe et al, the contents of which are incorporated in their entirety herein by reference.

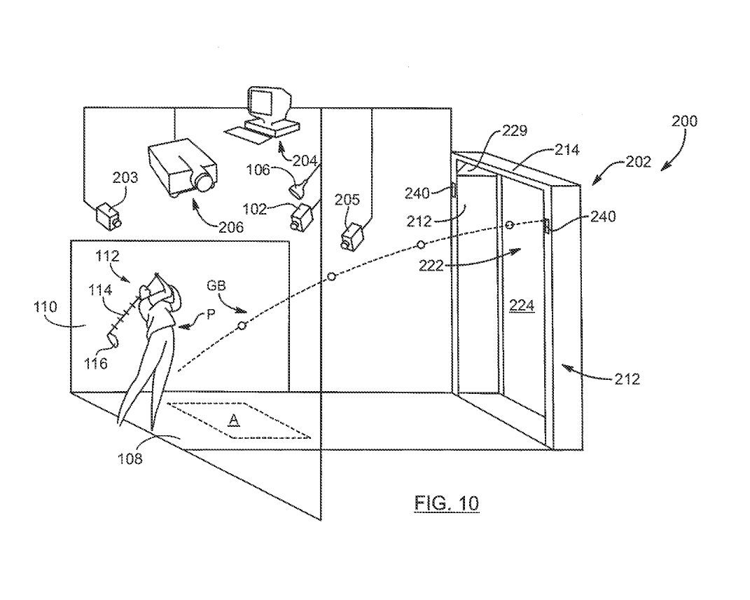

Turning now to FIG. 10, the apparatus 100 is shown in conjunction with the golf simulation system described in above-incorporated PCT Application No. PCT/CA2009/001424. As can be seen, sports simulation system 200 includes a golf ball tracking apparatus 202 disposed in front of a golf ball launch or hitting area A in which a player P stands. The launch area has a non-reflective floor 108 and a non-reflective background 110. In this embodiment, the separation distance between the launch area A and the golf ball tracking apparatus is approximately ten (10) feet. An overhead golf ball launch area sensing unit 203 is disposed above the launch area A. An overhead golf ball spin sensing unit 205 is positioned between the launch area A and the golf ball tracking apparatus 202. Imaging device 102 of the apparatus 100 is positioned in front of and above player P such that the optical axis of the imaging device 102 is generally perpendicular to the anticipated swing plane SP of the player P. Light source 106 is positioned adjacent imaging device 102 to provide an even distribution of illumination for both the player P and the imaging device 102. A host computer 204 is coupled to the imaging device 102, golf ball tracking apparatus 202, the golf ball launch area sensing unit 203 and the golf ball spin sensing unit 205 via a high-speed serial data link and to a ceiling mounted front video projector 206 that is aimed at the golf ball tracking apparatus 202. The host computer 204 outputs video image data to the projector 206, which in turn projects a video sequence on the golf ball tracking apparatus 202. The video sequence portrays a three-dimensional golf scene that comprises an image of a golf course hole, practice range etc.

In this embodiment, player P uses golf club 112 to launch the golf ball GB towards the golf ball tracking apparatus. The imaging device 102 captures image frames as the player P swings the golf club 112 to launch golf ball GB. Imaging device 102 outputs the image frames to the host computer 204, which functions as computing device 120, for processing.

The golf ball tracking apparatus 202 outputs two-dimensional golf ball position data to the host computer 204 when the launched golf ball GB travels through a golf ball tracking region monitored by the golf ball tracking apparatus. The golf ball launch area sensing unit 203 outputs image data representing the motion of the golf club 112 through the launch area A before, during and after impact with the golf ball to host computer 204. The golf ball spin sensing unit 205 outputs image data to the host computer 204 that allows the host computer 204 to determine the spin and the spin tilt axis of the golf ball GB as the golf ball travels through the golf ball tracking region. The host computer 204 in turn processes the two-dimensional golf ball position data, the golf ball launch area sensing unit image data and the golf ball spin sensing unit image data to determine the three-dimensional positions, launch velocity, acceleration, side spin, backspin, spin tilt axis and launch angle of the golf ball so that the trajectory of the golf ball can be accurately calculated. The calculated trajectory is then used to determine a sports result and to update the image data conveyed to the projector 206 so that the presented video sequence shows a simulation of the golf ball travel into the three-dimensional scene as well as the determined sports result.

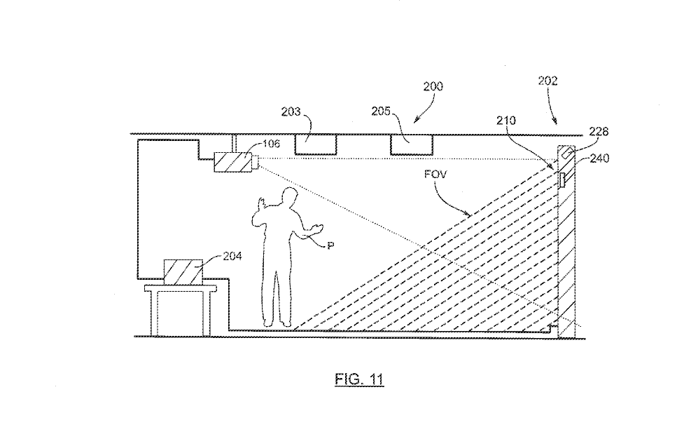

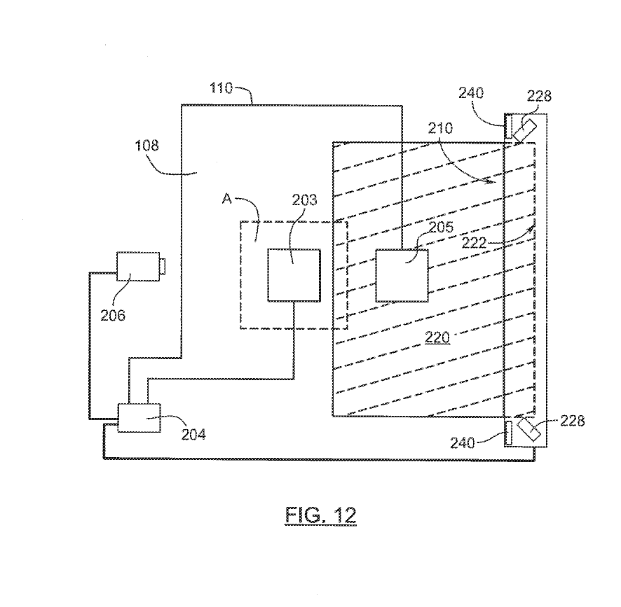

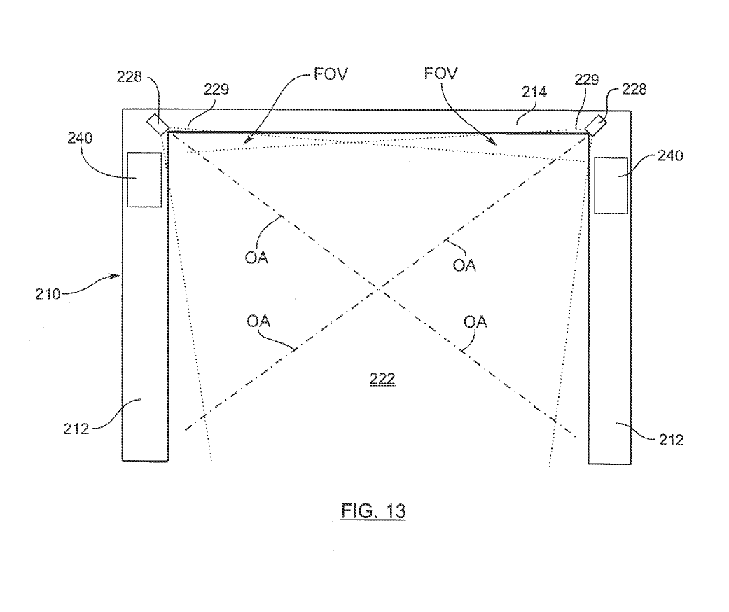

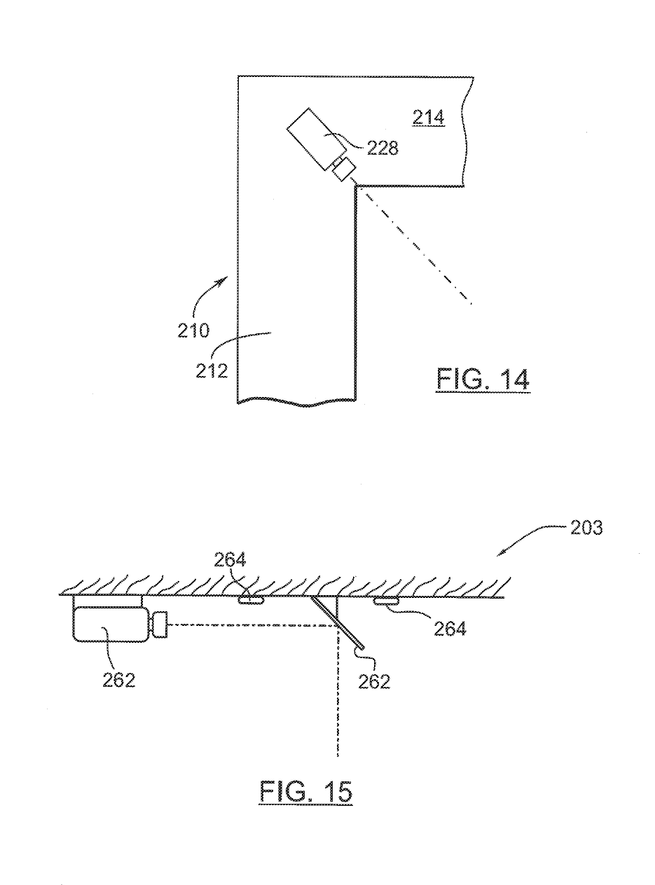

FIGS. 11 to 14 better illustrate the golf ball tracking apparatus 202. As can be seen, the golf ball tracking apparatus 202 comprises an upright, inverted U-shaped frame 210 having a pair of side posts 212 and a crossbar 214 extending between the upper ends of the posts 212. A screen 222 is supported by the frame 210. In this embodiment, the screen 222 has a 4:3 aspect ratio making it particularly suited for displaying conventional television images. Those of skill in the art will however, appreciate that other image formats can be used. The screen 222 is loosely fastened to the back of the frame 210 at spaced locations.

The screen 222 includes multiple layers and is designed to reduce golf ball bounce as well as enhance protection behind the screen. The first or front layer of the screen 222 is formed of highly reflective nylon having some elasticity to resist permanent stretching/pocketing and abrasion. As a result, the front layer provides an excellent display surface 224 on which images projected by the projector 206 are presented. The second or intermediate layer of the screen 222 is formed of soft and thick material and is designed to absorb golf ball energy with reduced elastic effect thereby to inhibit stretching and or damage to the front layer. The third or back layer of the screen 222 is formed of a tough heavy canvas to which the intermediate layer can transfer energy. The back layer also inhibits excess deformation of the intermediate layer when contacted by a launched golf ball. As a result, if the golf ball tracking apparatus 202 is placed adjacent a wall surface or the like, the back layer protects the surface behind the screen 222 from golf ball strike thereby to inhibit damage to the surface and/or significant golf ball rebound. If a space is provided behind the golf ball tracking apparatus 202, the back layer provides ample protection for the space.

Imaging devices, in this embodiment a pair of high speed digital cameras 228, are accommodated within the frame 210 with each camera being positioned adjacent a different top corner of the frame. Thus, the digital cameras 228 are positioned in front of the player P and to the left side and right side of the anticipated golf ball path. The digital cameras 228 are also angled to point downwardly and towards the player position so that the fields of view of the digital cameras are generally perpendicular and overlap in the golf ball tracking region which extends at least from the golf ball launch point to the screen 222. In this manner, the path of the golf ball can be tracked generally continuously from its launch point until it impacts the screen 222 and then as it rebounds from the screen 222.

In this embodiment, each digital camera 228 has at least a 640 by 480 pixel array and includes built-in processing capabilities comprising field programmable gate arrays, a high performance 32-bit microprocessor and high speed memory. The distributed processing capabilities achieved by using the digital cameras 228 and the host computer 204 allow the digital cameras to be operated at very high frame rates thereby allowing multiple images of a fast moving golf ball to be captured as the golf ball travels through the golf ball tracking region 220. This is due to the fact that the digital cameras 228 need only send data to the host computer 204 relating to images in which golf ball motion has been detected allowing high speed golf balls to be tracked without excessive bandwidth between the host computer 204 and the digital cameras 228 being needed. For example, in the case of a golf ball travelling through the golf ball tracking region 220 at a speed of 200 miles per hour, the frame rates of the digital cameras 228 are selected such that at least four images of the golf ball are captured by each digital camera 228. The viewing angles of the digital cameras 228 and the dimensions of the frame 210 are selected to provide the digital cameras 228 with a resolving accuracy of approximately 1 mm per pixel. As a result, a small golf ball such as a golf ball will activate approximately 12 pixels per image. This resolving accuracy enables even small, very fast moving launched golf balls to be readily determined in captured images and as a result, reduces false golf ball detection.

The on-board microprocessor of each digital camera 228 executes a motion detection routine to determine if a golf ball exists in the captured images and if so, whether the golf ball satisfies specified motion detection parameters defining a golf ball characteristic signature. The golf ball characteristic signature is used to ensure the detected golf ball has characteristics matching a struck golf ball. The golf ball can therefore be distinguished from other objects captured in the images such as for example, the golf club head. In this example, the golf ball characteristic signature specifies allowable golf ball size, shape, reflectivity and speed.

Infrared (IR) light emitting diode (LED) arrays (not shown) are also positioned within the posts 212 beside the digital cameras 228. The illumination axes of the IR LED arrays are generally coincident with the optical axes OA of the digital cameras. Each IR LED array emits IR radiation that is directed into the golf ball tracking region 220. As the digital cameras 228 are responsive to both visible and infrared light, providing the background IR illumination allows the golf ball tracking apparatus 202 to work well in a variety of ambient lighting conditions. In situations where a small fast moving golf ball is launched, the IR illumination allows for detection of the golf ball without interfering with the visual quality of the displayed image presented on the screen 222.

Audio speakers 240 are provided on the posts 212 and are aimed forwardly toward the launch area A. The audio speakers 240 are driven by an audio amplifier (not shown) accommodated within the frame 210. The audio amplifier receives audio input from the host computer 204 during play that is conveyed to the audio speakers 240 for broadcast thereby to enhance the sports experience.

The golf ball launch area sensing unit 203 is disposed directly over the launch area A and comprises an area-scan digital camera 260, an angled mirror 262, a plurality of illuminators 264 in the form of halogen spotlights and a power supply (not shown) for the spotlights 264 as shown in FIG. 15. The spotlights 264 are aimed to provide sufficient illumination in the launch area A to permit image capture without adversely affecting visibility of the image projected on the screen 222. The area-scan digital camera 260 is ceiling mounted in a horizontal orientation approximately ten (10) feet above the launch area A. The optical axis of the digital camera 260 is generally in line with the center of the mirror 262 so that the field of view of the area-scan digital camera 260 is re-directed downwardly and centered over the launch area A. In this embodiment, the field of view of the area-scan digital camera 260 encompasses a three (3) foot by three (3) foot region.

Similar to the digital cameras 228 in the golf ball tracking apparatus 202, the area-scan digital camera 260 comprises an on-board processor that executes a motion detection routine. During execution of the motion detection routine, as images are captured by the area-scan digital camera 260, the images are examined to determine if one or more moving objects exist therein that satisfy specified motion parameters. In this example, the motion parameters are selected to allow the on-board processor of the area-scan digital camera 260 to detect when either a moving golf club or moving golf ball or both is in captured images. Captured images including one or more moving objects satisfying the specified motion parameters are sent to the host computer 204 for further processing.

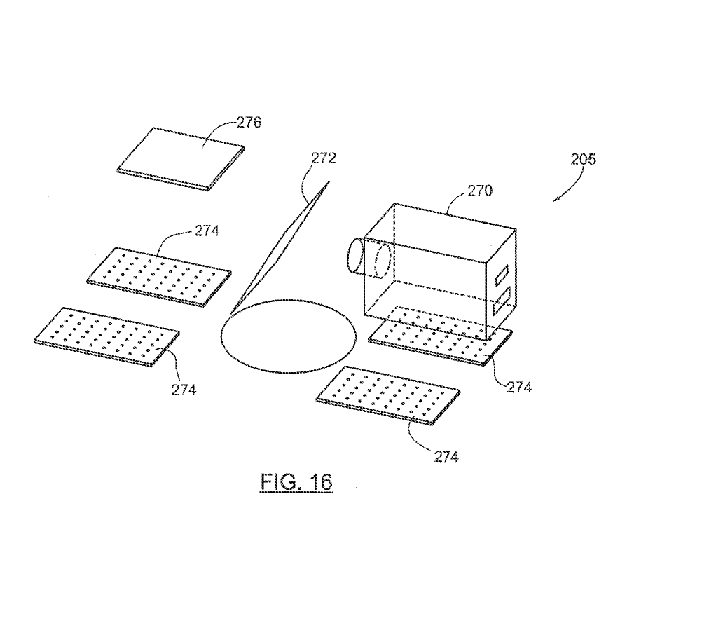

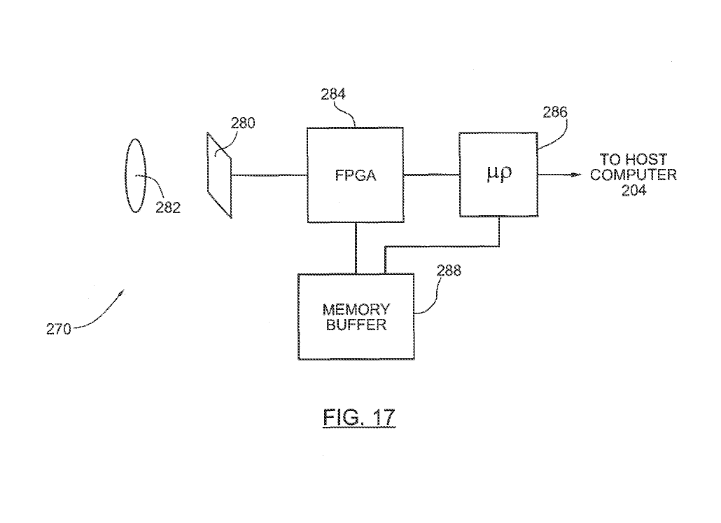

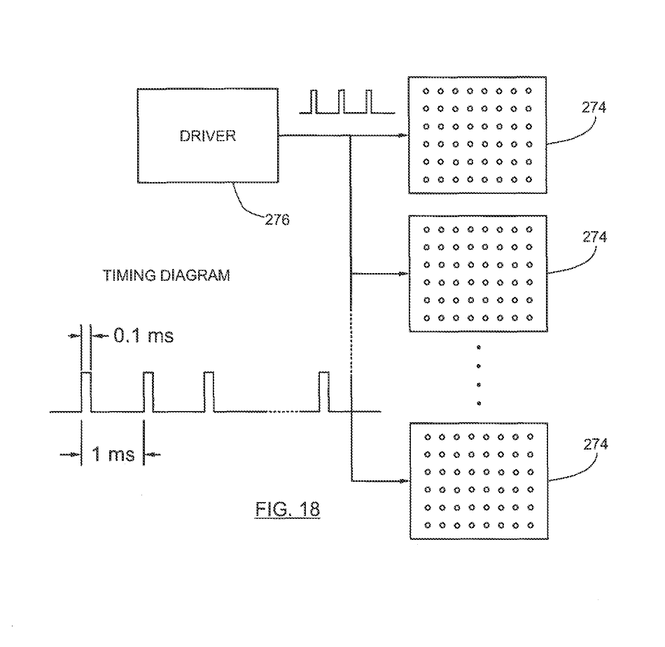

The golf ball spin sensing unit 205 comprises a ceiling mounted, horizontally oriented area-scan digital camera 270, an angled mirror 272, a plurality of infrared (IR) illuminator boards 274 and a driver 276 for the illuminator boards 274 as shown in FIG. 16. The optical axis of the digital camera 270 is generally in line with the center of the mirror 272 so that the field of view of the digital camera 270 is re-directed and centered over a region that at least partially overlaps with the golf ball tracking region. In this embodiment, the region extends from the front of the launch area A towards the golf ball tracking apparatus 202 and encompasses a three (3) foot by six (6) foot region.

FIG. 17 better illustrates the area-scan digital camera 270. In this embodiment, the digital camera 270 comprises a CMOS image sensor 280 having a 640 by 480 pixel array and a pixel size equal to about 9.9 microns. The image sensor 280 looks through a lens 282 having a focus distance of about twelve (12) millimeters. Such a lens has been found to provide good area coverage while maintaining sufficient resolution. The digital camera 270 includes built-in processing capabilities comprising a field programmable gate array (FPGA) 284, a high performance microprocessor 286 and a high speed memory buffer 288.

In this embodiment, the golf ball spin sensing unit 205 comprises four (4) illuminator boards 274, with each illuminator board comprising an array of light emitting diodes (LEDs). The illuminator boards 274 are arranged in a manner so that the region within the field of view of the digital camera 270 is generally evenly illuminated when the LEDs of the illuminator boards 274 are on. The driver 276 comprises a pulse generator that drives each of the illuminator boards 274 simultaneously so that the LEDs of the illuminator boards 274 turn on and off in unison at regular intervals. In this embodiment, the LEDs of the illuminator boards 274 remain in the on state for a 0.1 millisecond duration and remain in the off state for a 1 millisecond duration.

The projector 206 preferably has a resolution of at least 800×600, at least 1200 ANSI Lumens brightness, a short throw lens, vertical ‘keystone’ correction, and the capacity to accept digital RGB computer video signals, and NTSC/PAL baseband television video signals. Projectors having this set of features include the Epson Powerlite 820P, the Toshiba TDP-DI-US, the InFocus LP650 and the Sanyo XP30 for example.

The host computer 204 is a general purpose computing device. In this embodiment, host computer is an IBM compatible personal computer including an Intel Pentium® processor, at least 128 MB SDRAM, a high-speed hard drive, and a DVD player. The host computer 204 also includes a display adapter assembly including a reconfigurable 32-bit video memory buffer partitioned into three separate buffers. One of the buffers is used to store primary foreground image data representing one or more independent foreground action elements if appropriate for the sports scene being displayed. A second of the buffers is used to store background image data and the third buffer is used to store golf ball trajectory image data. The display adapter assembly treats the foreground action, background and golf ball trajectory image data as overlay image planes that are combined seamlessly to generate the video image data that is output to the projector 206. The overlay image planes are non-destructive so that when a foreground action element and/or golf ball moves over an underlying image plane it is not necessary to redraw the underlying image plane. To reduce peak processing requirements, the host computer 204 updates the background image data less frequently than the foreground image data. The host computer 204 provides the output video image data to the projector 206 on a video output channel. The host computer 204 receives external video feeds on a television/satellite/cable input channel, a video game input channel and an Internet input channel.

The host computer 204 is mounted within a protective enclosure (not shown) having external connectors to enable the host computer 204 to be coupled to the projector 206, the golf ball tracking apparatus 202, the golf ball launch area sensing unit 203 and the golf ball spin sensing unit 205. The enclosure also includes external connectors to allow the host computer 204 to receive the television/satellite/cable, external video game and Internet feeds. An interactive touch screen is also provided on the enclosure to allow a player to interact with the host computer 204.

A high speed digital serial interface, such as for example IEEE 1394, is used for communications between the host computer 104, the golf ball tracking apparatus 102, the golf ball launch area sensing unit 103 and the golf ball spin sensing unit 105. Using this standard interface provides a low cost, high performance solution while avoiding use of expensive analog frame grabbers. The interface also simplifies wiring as the digital cameras 128 can be daisy-chained without loss of signal integrity.

The host computer 204 executes sports simulation software stored in the SDRAM. In this example, the sports simulation software includes a golf simulation module that requires a player to hit the golf ball GB at the screen 222 of the golf ball tracking apparatus 202 in response to the video sequence displayed on the screen 222.

To provide a realistic playing experience, a high resolution elevation map of the golf course terrain is used. The course terrain elevation map is constructed from a combination of two-dimensional images that include overhead satellite and/or aerial photographs used in conjunction with digital photographs taken from ground level. Using photogrammetry techniques, these orthogonal views are combined together. Using common points in the images i.e. edges of sand hazards, trees etc., a three-dimensional model is synthesized without requiring reference targets to be applied to the terrain of interest.

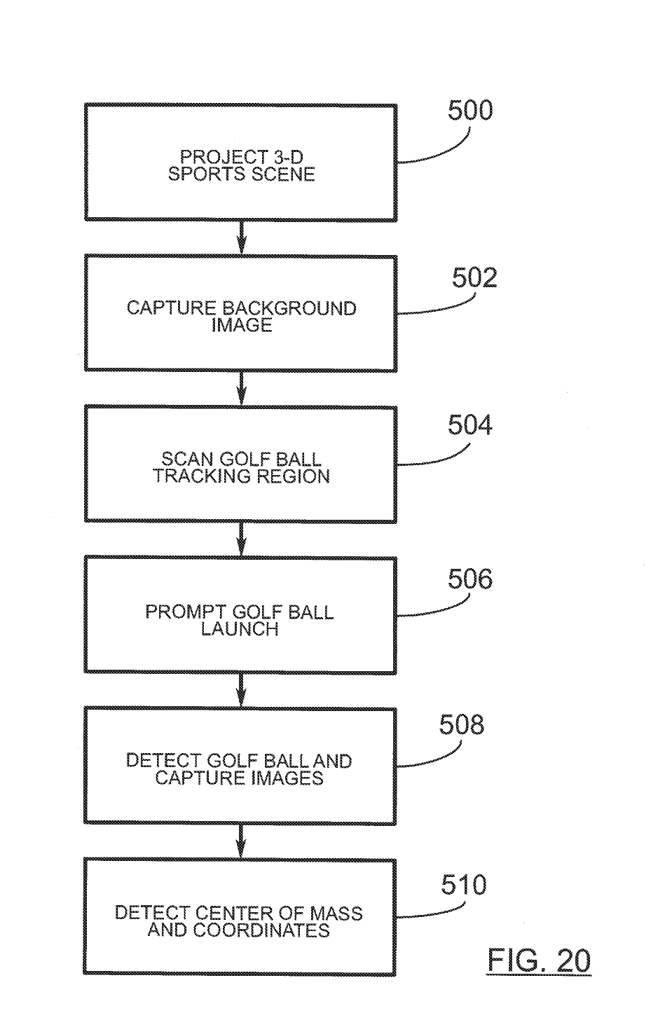

During training, practice or game play, the host computer 204 outputs video image data to the projector 206 causing the projector 206 to project a video sequence portraying a three-dimensional sports scene on the display surface 224 that includes a target at which the golf ball is to be launched (see step 500 in FIG. 20). The host computer 204 also conditions the digital cameras 228 to capture a background image of the golf ball tracking region 220 devoid of a golf ball (step 502) and then scan the golf ball tracking region to look for the presence of a launched golf ball at a very high frame rate (step 504). The player is then prompted to launch the golf ball GB at the screen 222 (step 506). At this stage, the digital cameras 228, the area-scan digital camera 160 and the area-scan digital cameral 270 are conditioned to capture and process images.

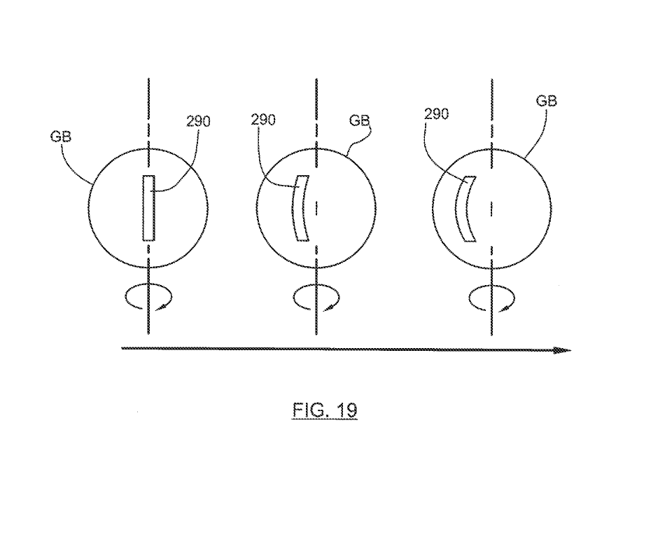

To facilitate detection of golf ball spin, an elongate reflective or retroreflective marker 290 is provided on the golf ball GB (see FIG. 19). In this embodiment, the marker is a 45 mm by 5 mm piece of reflective tape adhered or otherwise secured to the golf ball GB. Prior to launch, the golf ball GB is preferably oriented so that the long dimension of the reflective tape 290 is parallel to the width of the screen 222. As a result, after launch and while the golf ball backspins as it travels through the field of view of the area-scan digital camera 270, when the driver 276 turns the LED arrays of the illuminator boards 274 on, the reflective tape 290 is clearly visible to the area-scan digital camera 270 at intervals.

When the player launches the golf ball at the golf ball tracking apparatus 202 by striking the golf ball with a golf club 112 and the golf ball enters the golf ball tracking region 220, the golf ball appears in the images captured by the digital cameras 228. Thus, the digital cameras 228 generally synchronously capture a series of images of the golf ball as it travels from its launch point through the golf ball tracking region 220 to its contact point with the screen 222 and then as the golf ball rebounds off of the screen (step 508). The captured images are in turn processed by the on-board processors of the digital cameras 228 to determine if the captured images include a detected golf ball satisfying the golf ball characteristic signature.

If the detected golf ball satisfies the golf ball characteristic signature, the images are further processed to determine the center of mass of the golf ball in each image and its position in rectangular coordinates (step 510). As a result, a series of two-dimensional rectangular coordinates representing the two-dimensional positions of the golf ball as it travels through the golf ball tracking region 220 relative to each digital camera 228 is generated. The two-dimensional rectangular coordinates generated by the digital cameras 228 are in turn conveyed to the host computer 204.

The area-scan digital camera 260 of the golf ball launch area sensing unit 203 captures and processes images to look for the existence of a swinging golf club 112 passing through the launch area A and the launched golf ball exiting the launch area A. When a swinging golf club and launched golf ball are detected, the area-scan digital camera 260 outputs the captured images to the host computer 204.

The area-scan digital camera 270 of the golf ball spin sensing unit 205 captures images at a frame rate equal to about 100 frames per second (fps) and processes consecutive images to determine if the difference between consecutive images exceeds a threshold signifying the existence of an object in motion. When the difference between consecutive images exceeds the threshold, images are further processed to determine if the object in motion resembles a golf ball. If the object in motion resembles a golf ball, the images are sent to the host computer 204 for further processing.

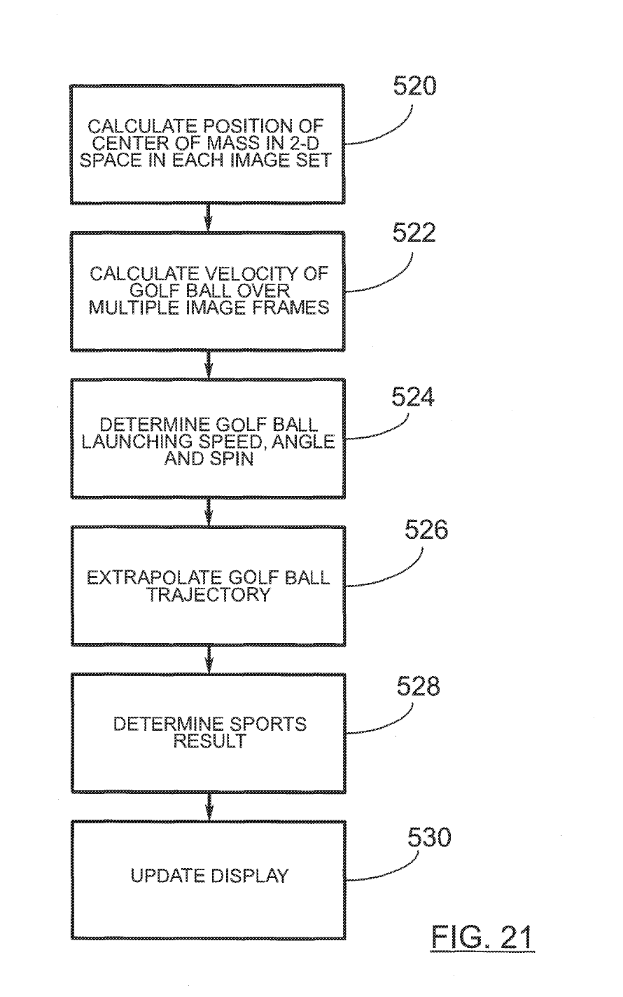

Upon receipt of the golf ball coordinates from the golf ball tracking apparatus 202, the host computer 204 calculates the positions of the golf ball's center of mass in three-dimensional space throughout its travel through the golf ball tracking region 220 including its collision and rebound with the screen 222 using triangulation techniques (see step 520 in FIG. 21). With the position of the golf ball in three-dimensional space known during its travel through the golf ball tracking region 220 and knowing the frame rates of the digital cameras 228, the host computer 204 calculates the launch velocity of the golf ball and the velocity of the golf ball over each image frame (step 522). The host computer 204 then compares each calculated velocity with the previously calculated velocity to determine the acceleration of the golf ball (step 524).

Upon receipt of the image data from the golf ball launch area sensing unit 203, the host computer 204 analyzes the club head swing path 300 (see FIG. 23) to determine where the club head hits the golf ball GB and to determine the initial golf ball trajectory or launch angle after being hit. The host computer 204 also defines a club head motion vector 302 as the tangent line along the club head swing path 300. By estimating the initial golf ball trajectory, a golf ball motion vector 306 is measured. Using this vector, a club face vector 308 can be determined as the line perpendicular to the tangent 310 of the club face at the impact point of the golf ball and the club face. By comparing the club head motion vector 302 and the club face vector 308, a determination can be made as to whether the club face is open or closed upon impact with the golf ball. The degree to which the club head motion vector 302 is not parallel to the club face vector 308 at the point of impact determines the amount of side spin that the golf ball will have. This enables the host computer 204 to calculate the side spin of the golf ball based on the angle of the club face at the point of contact with the golf ball as well as on the impact and rebound angles of the golf ball with and from the screen 222 (also step 524).

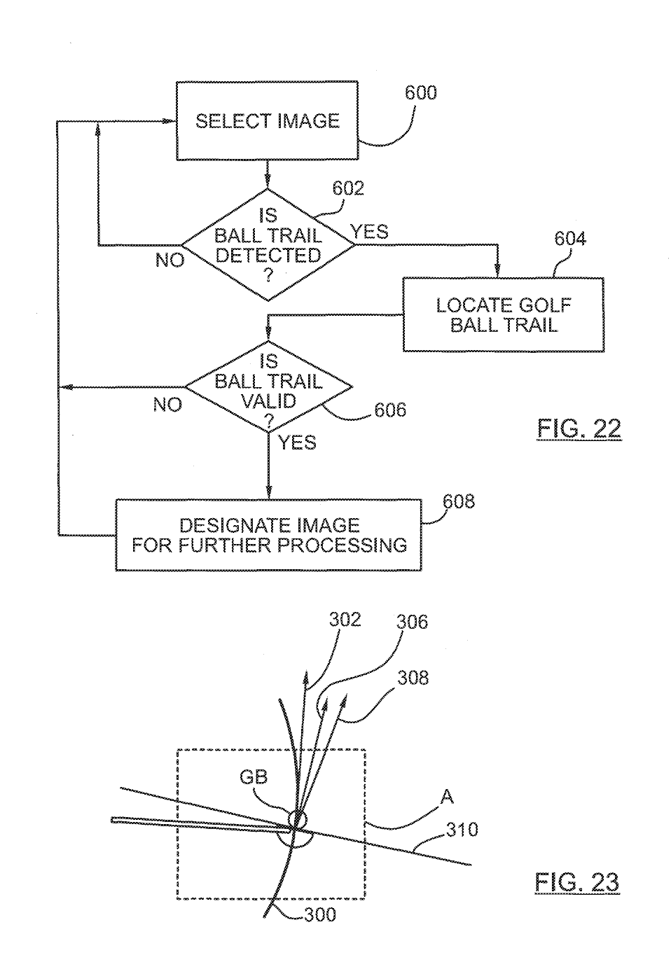

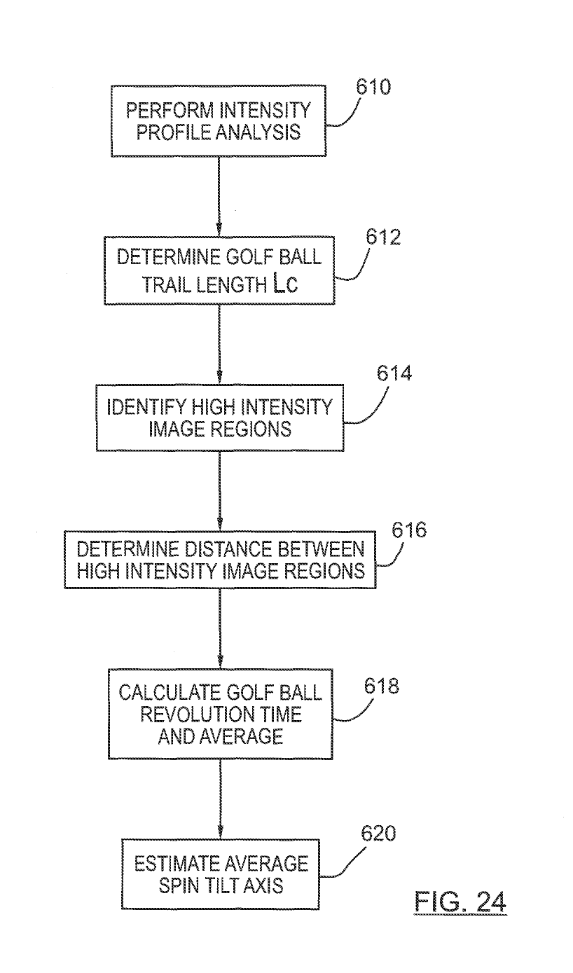

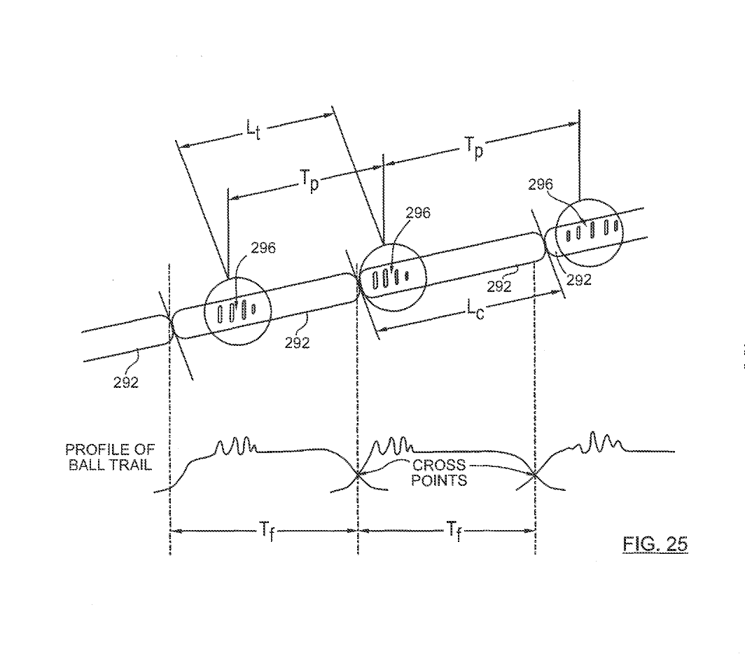

Upon receipt of the images from the golf ball spin sensing unit 205, the host computer 204 selects the first image (see step 600 in FIG. 22a) and analyses the image to determine if the image includes a golf ball trail 292 (step 602) as shown in FIG. 24. The golf ball trail 292 appears in images due to the fact that velocity of the golf ball GB exceeds the frame rate of the digital camera 270. If the image does not include a golf ball trail, the image is discarded and the next image is selected at step 600. If the selected image includes a golf ball trail 292, the golf ball trail in the image is located (step 604) and is then examined to determine if it is valid (step 606). In particular, the length and width of the golf ball trail are compared with the threshold ranges. If the golf ball trail is not valid, the selected image is discarded and the next image is selected at step 600. If the golf ball trail 292 is validated at step 606, the image with the valid golf ball trail is designated for further processing (step 608) and the process reverts back to step 600 where the next image is selected.

Once all of the images from the golf ball spin sensing unit 205 have been selected and processed, the images designated for further processing at step 608 are subjected to an image intensity profile analysis (step 610 in FIG. 22b) thereby to generate a combined profile of the golf ball trail over consecutive images as shown in FIG. 24. The golf ball trail length L_{c} per image is determined by the cross points of the combined profile (step 612). The images are subjected to adaptive thresholding to identify high intensity regions 296 in the images corresponding to the illuminated reflective tape 290 (step 614). A group of high intensity regions 296 corresponding to the reflective tape 290 appears in each image due to the golf ball spin and the pulsed illumination provided by the illuminator boards 274. The distance between the group of high intensity regions 296 in each consecutive image is then determined and is represented by Lₜ in FIG. 24 (step 616). The time Tₚ taken for the golf ball GB to make a single revolution is expressed as:

$${T}_{p} = \frac{{L}_{t}}{{L}_{c}} \cdot {T}_{f}$$

where T_{f} is the frame rate of the digital camera 170.

The time Tₚ is calculated for each consecutive image designated for further processing at step 608 and the average single rotation time for the golf ball GB to make a signal revolution is determined (step 618). The average single rotation time is then converted into convenient units such as for example rotations per minute (rpms).

The ball spin tilt axis is then estimated for each image using the orientation of the high intensity regions 296 in each group and the relative angle between the longitudinal axis of the high intensity regions 296 and the longitudinal axis of the golf ball trail 292. The average ball spin tilt axis over the consecutive images designated for further processing at step 608 is then determined (step 620).

With the three-dimensional positions, launch velocity, acceleration, side spin, launch angle, backspin and spin tilt axis of the golf ball known, the host computer 204 extrapolates an accurate trajectory for the golf ball allowing a realistic simulation of curved and/or arcing golf balls to be generated (step 526). The computed golf ball trajectory is then used to determine a sports result by computing the intersection of the calculated golf ball trajectory with the displayed video image (step 528). With the golf ball trajectory computed and the sports result determined, the host computer 204 updates the image data that is conveyed to the projector 206 so that the video sequence displayed on the display surface 224 of the screen 222 shows the simulated flight of the golf ball and the sports result (step 530).

During video sequence display, when a simulation of the golf ball flight is shown a graphical duplicate of the golf ball is projected onto the display surface 224 of the screen 222 that begins its flight from the impact point of the golf ball with the screen 222. In this manner, the golf ball appears to continue its trajectory into the video scene thereby to achieve a realistic video effect. The three-dimensional scene is then updated in accordance with the sports result, allowing game play or practice to continue.

Although the apparatus 100 has been described as using a single imaging device 102, multiple imaging devices may be used. If two imaging devices are employed, the imaging devices are preferably positioned at a distance apart from one another and configured to form a stereo pair. In this case, the image frames captured by the imaging devices provide a third dimension for image processing.

Although the apparatus 100 has been described as utilizing two reference points (tape pieces 118 and 126), and three intermediate markers (tape pieces 120, 122 and 124), more or fewer markers may be used. For example, the apparatus may determine the flex ratio based on only one marker. Alternatively the entire shaft 114 may be covered with a single marker (e.g. a long piece of retroreflective tape) allowing the entire curvature of the shaft to appear in captured image frames during a golf swing.

Although the image processing used by apparatus 100 has been described as taking reference points along the shaft, and measuring the distance from those reference points to a straight line, the reference points can be used to find the shaft location of non-marked shaft sections by means of interpolation and/or extrapolation. In this way, the flex ratio at any point on the shaft can be determined.

In the embodiment described above, the imaging device 102 is a digital camera utilized to capture images of player's golf swing. As one of ordinary skill in the art would appreciate, there is typically an upper limit to the number of image frames that the digital video camera can capture. This does not limit the ability to interpolate and extrapolate data. Similar to interpolating data for shaft flex, the computing device can be configured to interpolate data between any two consecutive image frames captured by the imaging device. At impact the club head 116 slows down and transfers energy to the golf ball. The data obtained by processing the image frames can be extrapolated to predict the shaft flex up to the point of impact. Combining the data obtained from interpolating/extrapolating the reference points on the shaft with the data obtained from interpolating/extrapolating image frames, results in a complete measurement for shaft flex at any point on the shaft and at any time during the up-swing and the down-swing components of the golf swing.

Although the markers on the shaft have been described as being pieces of retroreflective tape, other markers such as reflective tape, retroreflective paint or reflective paint may be utilized. Alternatively, the shaft may have reference markers incorporated into the material in which the shaft is made, providing a club-fitting shaft for use by club-fitters when fitting a customer for a potential order.

While the apparatus has been described as determining the flex of a golf club shaft, the apparatus may be utilized to determine the flex of other types of sports equipment, such as tennis racquets and hockey sticks.

Although the golf simulation system 200 has been described as including a ceiling mounted front projector 206 in combination with a screen 222, those of skill in the art will appreciate that alternative projection devices may be used. For example, a rear video projector may be used to project images onto the rear surface of the display screen 222.

Those of skill in the art will appreciate that the golf ball tracking apparatus 202 may include imaging devices at different locations to view the golf ball tracking region and detect the existence of a launched golf ball. Those of skill in the art will also appreciate that the number of processing stages may be increased or decreased as desired to handle processing of the digital camera image data effectively in real-time and provide a realistic golf ball simulation.

If desired, the golf ball launch area sensing unit 203 and the golf ball spin sensing unit 205 may include additional camera devices. The golf ball launch area sensing unit 203 and golf ball spin sensing unit 105 may include any number of illuminators or none at all if the ambient light conditions are sufficient to provide for adequate image capture. Further, although the golf ball launch area sensing unit 203 and golf ball spin sensing unit 205 are shown to include mirrors to re-direct the fields of view of the area-scan digital cameras 260 and 270, those of skill in the art will appreciate that the area-scan digital cameras may be oriented to look directly at the regions of interest. The golf ball launch area sensing unit 203 and golf ball spin sensing unit 205 may also be positioned at any convenient location.

While the sports simulation system is described as simulating golf, it will be appreciated that the sports simulation system may be used to simulate other sports where a projectile is launched. In such cases, the projectile characteristic signatures are updated to enable launched projectiles to be accurately tracked.

Although embodiments have been described above with reference to the drawings, those of skill in the art will appreciate that variations and modifications may be made without departing from the spirit and scope thereof as defined by the appended claims.

What is claimed is:

1. A method for measuring shaft flex comprising:
capturing at least one image of a shaft during movement of the shaft through a swing plane; and
examining the at least one image to determine the flex of the shaft.

2. The method of claim 1, wherein the capturing comprises capturing a series of images during the movement of the shaft through the swing plane, and the examining comprises examining multiple images to determine the flex of the shaft at multiple positions along the swing plane.

3. The method of claim 2 wherein the examining comprises determining a flex profile for the shaft over the movement of the shaft through the swing plane.

4. The method of claim 1 wherein the examining comprises measuring a deviation of at least one discrete point along the shaft from a fixed reference to determine shaft flex.

5. The method of claim 1 wherein the examining comprises measuring deviations of a plurality of discrete points along the shaft from a fixed reference to determine shaft flex.

6. The method of claim 5 wherein the examining comprises comparing the deviations to determine a maximum deviation, the maximum deviation representing the flex of the shaft.

7. The method of claim 4 wherein the fixed reference is a straight line extending between a pair of reference points adjacent opposite ends of the shaft.

8. The method of claim 7 wherein the at least one discrete point is located intermediate the pair of reference points.

9. The method of claim 4 wherein the at least one discrete point is defined by a reflective marking on the shaft.

10. The method of claim 7 wherein the pair of reference points are defined by reflective markings on the shaft.

11. The method of claim 1 wherein said shaft is the shaft of a golf club.

12. An apparatus for measuring shaft flex comprising:
at least one imaging device capturing images of a shaft during movement of the shaft through a swing plane; and
processing structure processing image data captured by the at least one imaging device to determine the flex of the shaft.

13. The apparatus of claim 12 wherein the optical axis of the at least one imaging device is generally perpendicular to the swing plane.

14. The apparatus of claim 12 comprising an illumination source.

15. The apparatus of claim 12 wherein the at least one imaging device captures a series of images of the shaft during movement of the shaft through the swing plane, and the processing structure is configured to process multiple images to determine the flex of the shaft at multiple positions along the swing plane.

16. The apparatus of claim 15 wherein the processing structure determines a flex profile for the shaft over the movement of the shaft.

17. The apparatus of claim 12 wherein the processing structure is configured to measure the deviation of at least one discrete point along the shaft from a fixed reference.

18. The apparatus of claim 12 wherein the processing structure is configured to measure deviations of a plurality of discrete points along the shaft from a fixed reference.

19. The apparatus of claim 18 wherein the processing structure is configured to compare the deviations to determine a maximum deviation, the maximum deviation representing the flex of the shaft.

20. The apparatus of claim 17 wherein the fixed reference is a straight line extending between a pair of reference points adjacent opposite ends of the shaft.

21. The apparatus of claim 20 wherein the at least one discrete point is located intermediate the pair of reference points.

22. The apparatus of claim 17 wherein the at least one discrete point is defined by a reflective marking on the shaft.

23. The apparatus of claim 20 wherein the pair of reference points are defined by reflective markings on the shaft.

24. The apparatus of claim 12 wherein said shaft is a golf club shaft.

25. A golf simulation system comprising:
an apparatus for measuring shaft flex according to claim 11;
a golf ball tracking apparatus comprising at least two imaging devices capturing images of a golf ball tracking region disposed in front of a display surface from different vantages to detect a launched golf ball traveling through the golf ball tracking region towards the display surface; and
at least one processing unit receiving data from the imaging devices and determining the three-dimensional positions, velocity and acceleration a detected launched golf ball traveling through the golf ball tracking region, the three-dimensional positions, velocity and acceleration being used by the at least one processing unit to calculate a trajectory of the launched golf ball into a three-dimensional golf scene.

26. The golf simulation system of claim 25 further comprising:
a golf ball spin sensing unit capturing images of a region at least partially overlapping with the golf ball tracking region, each captured image comprising a golf ball trail representing a travel path of the golf ball when a golf ball is present in the region during image capture.

27. The golf simulation system of claim 25 wherein the at least one processing unit uses the calculated trajectory to generate updated image data including a simulation of the launched golf ball into the three-dimensional golf scene following the calculated trajectory.

28. The golf simulation system of claim 27 further comprising a projection device coupled to the at least one processing unit, the projection device receiving image data from the at least one processing stage and presenting the three-dimensional golf scene including the simulation on the display surface.

29. The golf simulation system of claim 25 wherein the golf ball tracking apparatus includes a frame and at least one pair of camera devices mounted on the frame, the camera devices having overlapping fields of view looking across and in front of the display surface and capturing images of the golf ball tracking region.
